(19) United States
(12) Patent Application Publication
(10) Pub. No.: US 2010/0115850 A1
(43) Pub. Date: May 13, 2010

(54) COMPOSITE PROFILE AND INSULATING STRIP THEREFOR

(75) Inventors: Thorsten Siodla, Baunatal (DE); Erwin Brunnhofer, Fuldabrueck (DE)

Correspondence Address: J-TEK LAW PLLC, 601 Pennsylvania Avenue, NW, Suite 900, South Building, Washington, DC, 20004, US

(73) Assignee: TECHNOFORM CAPRANO UND BRUNNHOFER GMBH & CO. KG, Fuldabrueck (DE)

(21) Appl. No.: 12/594,337

(22) PCT Filed: Mar. 31, 2008
(86) PCT No.: PCT/EP08/02543

§ 371 Date: Oct. 1, 2009

(30) Foreign Application Priority Data
Apr. 2, 2007 (DE) 20 2007 004 935.8
Jun. 28, 2007 (DE) 20 2007 009 106.0
Nov. 27, 2007 (DE) 20 2007 016 649.4
Mar. 31, 2008 (EP) PCT/EP2008/002543

(51) Int. Cl. E06B 7/16

(52) U.S. Cl. 49/493.1

(57) ABSTRACT

An insulating strip for a composite profile for window-, door- and facade elements includes an insulating strip body that extends in a longitudinal direction and has at least two longitudinal edges separated from each other in a transverse direction. The longitudinal edges are designed for a shear-resistant connection with profile parts of the composite profile. The insulating strip body has openings passing through one or more walls of the insulating strip body in a height direction. The openings are separated from each other by strips in the longitudinal direction, which strips are shaped like ladder rungs. The insulating strip body is formed to receive a clipped-on covering profile that covers the openings.

The present invention relates to a ladder-shaped insulating strip for a composite profile for window-, door- and facade elements and a composite profile for window-, door- and facade elements.

Insulating strips for composite profiles for window-, door- and facade elements and composite profiles for window-, door- and facade elements are known, e.g., from DE 296 23 019 U1 (EP 0 829 609 B1), DE 197 35 702 A1, DE 298 21 183 U1 (EP 1 004 739 B1), DE 199 56 415 C1, DE 198 18 769 A1 and DE 198 53 235 A1.

An insulating strip is known from DE 198 18 769 A1 that is comprised of plastic and an embedded metal insert. The metal insert and the plastic have openings that result in a ladder-shaped structure of the ladder strip. The metal insert serves to prevent a total failure of the insulating strip in case of fire. The purpose of the openings in the metal insert is to reduce heat conductivity.

It is an object of the invention to provide an insulating strip (thermal isolating strip) for a composite profile, which facilitates a sufficiently high shear rigidity with improved thermal isolation, and a composite profile improved in this manner.

This object is achieved by an insulating strip according to claim 1, a covering profile according to claim 4 and a composite profile according to claim 5, respectively.

Further developments of the invention are provided in the dependent claims.

A composite profile, in particular a metal composite profile, is provided, in which the outwardly-located profile parts (e.g., outer frame and inner frame) made, e.g., of metal, are connected using one or more insulating strips made of plastic. A relative movement in the longitudinal direction is limited and/or prevented by the high shear rigidity (characteristic of the rungs in width, thickness, length, number).

The insulating strips are advantageously manufactured initially from a suitable material, e.g., by extrusion, as profile parts having a constant cross-section along the length. Thereafter, the rungs and/or more precisely the openings are produced by a processing such as a machine processing (e.g., milling), cutting (e.g., laser cutting, water jet cutting), punching, etc. The removed material can be recycled.

The metal profiles are fixedly and thus undetachably connected with the insulating strip.

The insulating strips can be provided with covering profiles or covering foils for covering the intermediate spaces between the rungs. The covering profiles or covering films can be, e.g., clipped-on, adhered-on, extruded-on, laminated-on, etc. In the alternative or in addition, it is also possible to fill up the intermediate spaces between the ladder rungs with a material that has a lower heat conductivity coefficient than the material of the rungs. The function of such a covering profile, etc., is, on the one hand, to protect against the penetration of moisture and, on the other hand, the protection of the inner core. The covering profiles or covering films can be attached before or after the mounting of the doors. The protection against moisture can be ensured with the covering profiles or covering films. In addition, decorative elements can be attached. For example, the covering element can be made electronically conductive and thus assume the color of the metal profile during the powder lacquering. Printing thereon is also possible.

One advantage is that the U-values (heat conductivity properties) of the insulating strip are not inordinately diminished by the attachment of the covering film/covering profile/filling.

Further features and advantages will follow from the description of the exemplary embodiments with the assistance of the Figures. In the Figures:

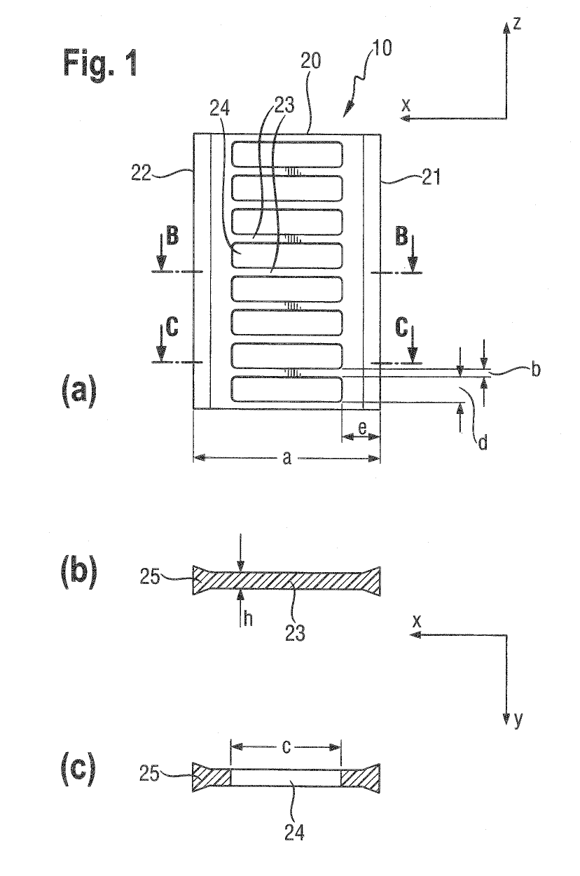

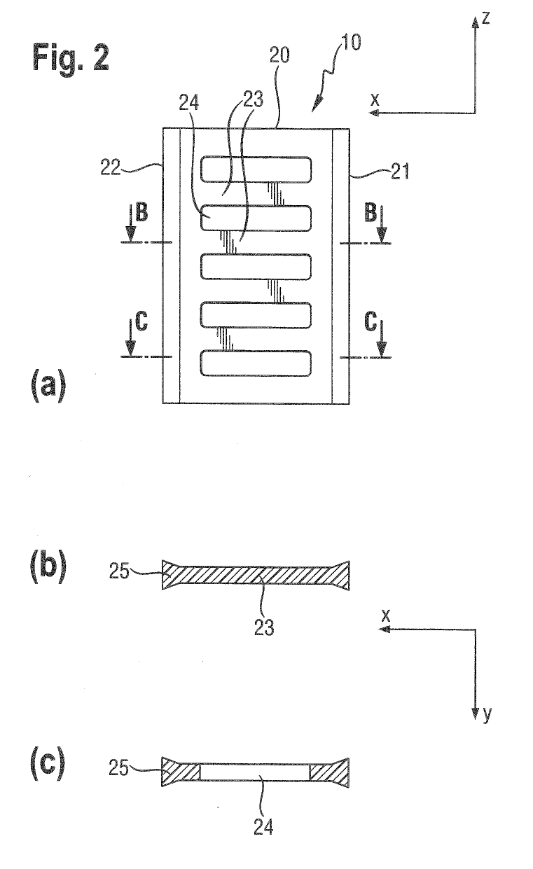

FIG. 1 shows a first embodiment of an insulating strip, in a) in plan view, in b) in the cross-section perpendicular to the longitudinal direction along the line B-B from FIG. 1a), and in c) in the cross-section perpendicular to the longitudinal direction along the line C-C from FIG. 1a);

FIG. 2 shows a second embodiment of an insulating strip having another rung width in views corresponding to FIG. 1;

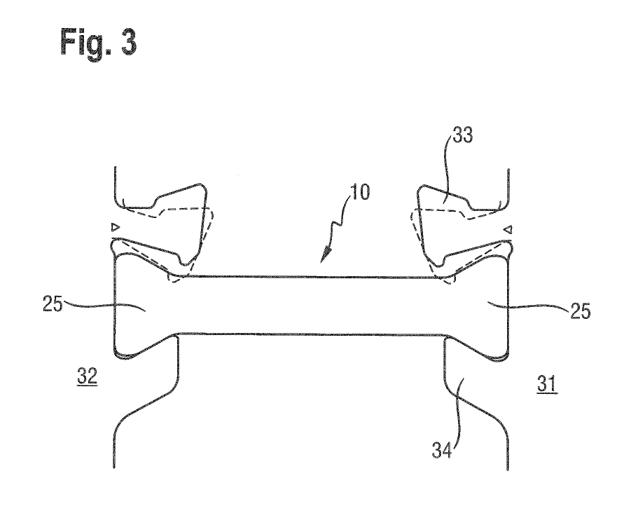

FIG. 3 shows a cross-sectional view perpendicular to the longitudinal direction of an insulating strip when being connected with the inner- and outer profile parts of a composite profile by rolling-in;

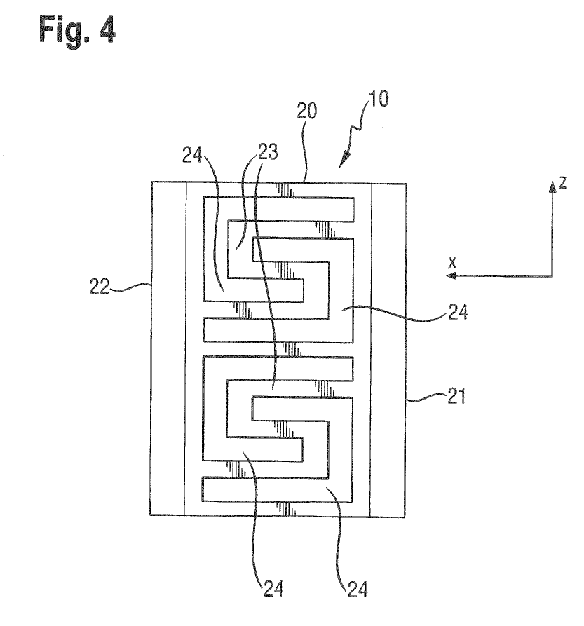

FIG. 4 shows a third embodiment of an insulating strip having meander-shaped rungs of the ladder-like structure in a view corresponding to FIG. 1 a);

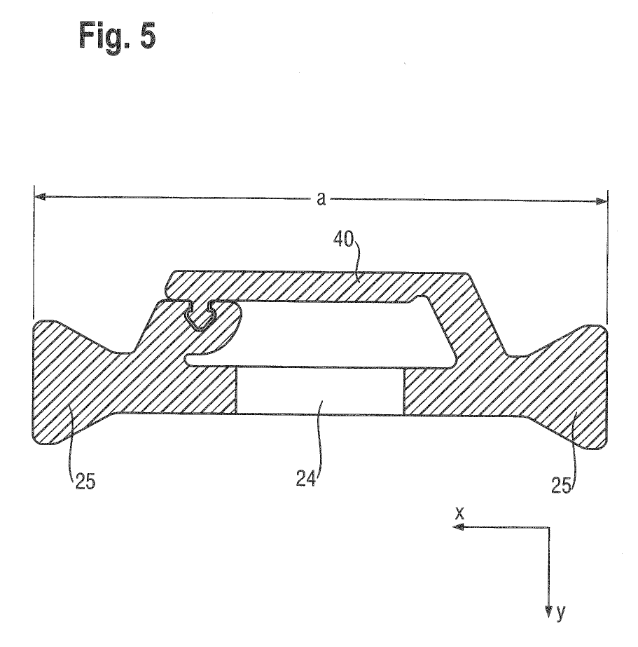

FIG. 5 shows a fourth embodiment of an insulating strip having an in situ extruded cover in a view corresponding to FIG. 1 c);

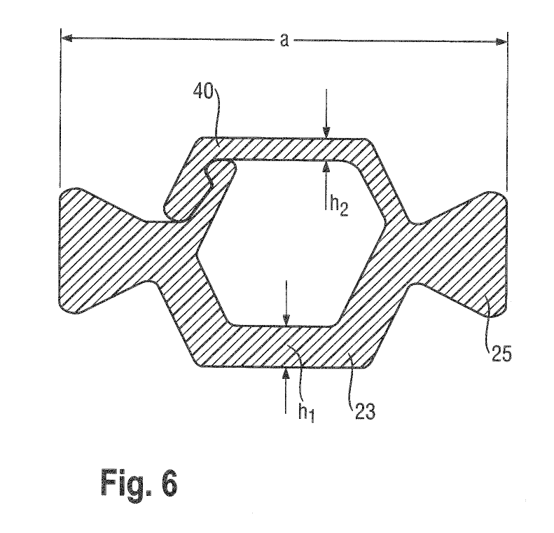

FIG. 6 shows a modification of the fourth embodiment;

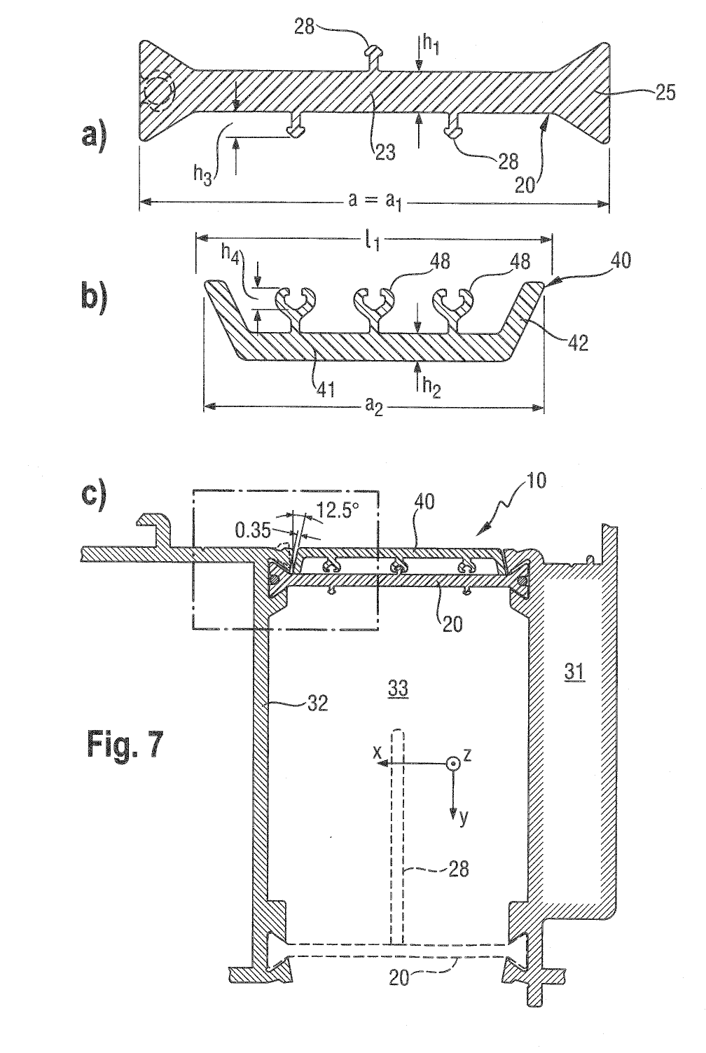

FIG. 7 shows a fifth embodiment of an insulating strip, in a) in the cross-section of the insulating strip body perpendicular to the longitudinal direction, in b) in the cross-section of a to-be-clipped-on covering profile perpendicular to the longitudinal direction, and in c) in the installed state between two metal profiles in the cross-section perpendicular to the longitudinal direction; and

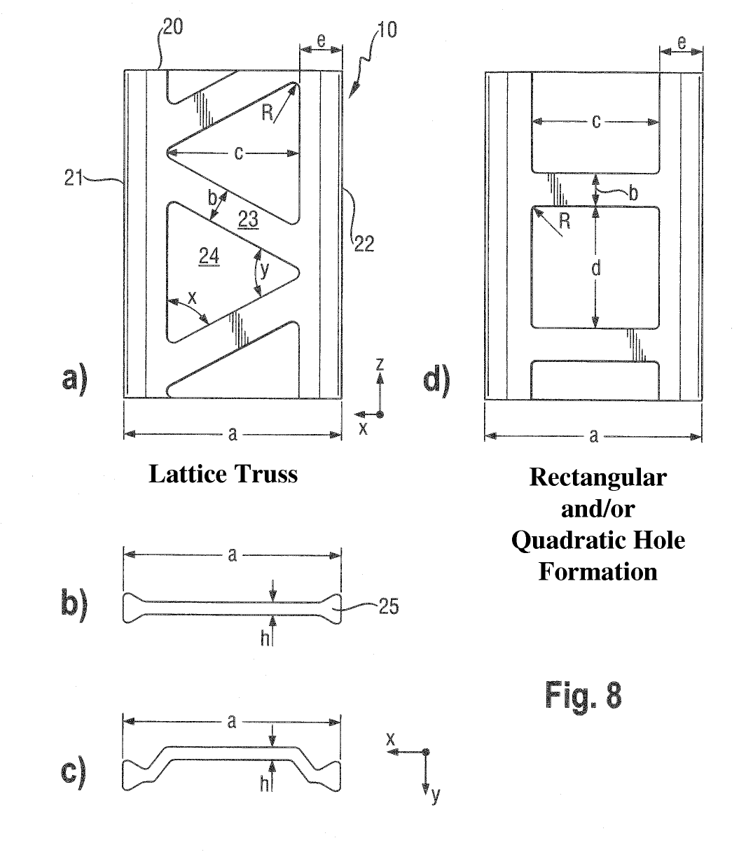

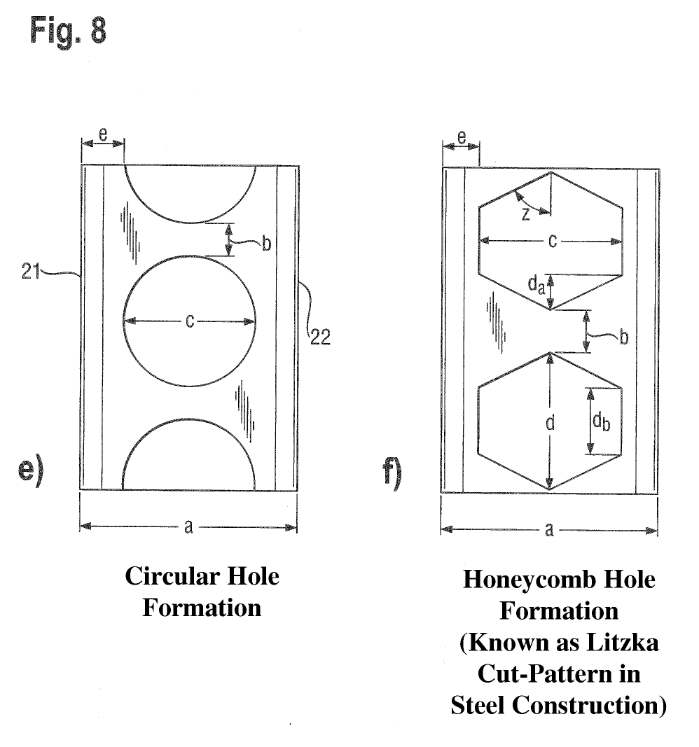

FIG. 8 shows in the views a), b) a sixth embodiment of an insulating strip, in a) in plan view perpendicular to the longitudinal direction and in b) in the cross-section perpendicular to the longitudinal direction, in view c) a modification of the sixth embodiment in the cross-section perpendicular to the longitudinal direction, in d) a seventh embodiment in plan view perpendicular to the longitudinal direction, in e) an eighth embodiment in plan view perpendicular to the longitudinal direction, and in f) a ninth embodiment in plan view perpendicular to the longitudinal direction;

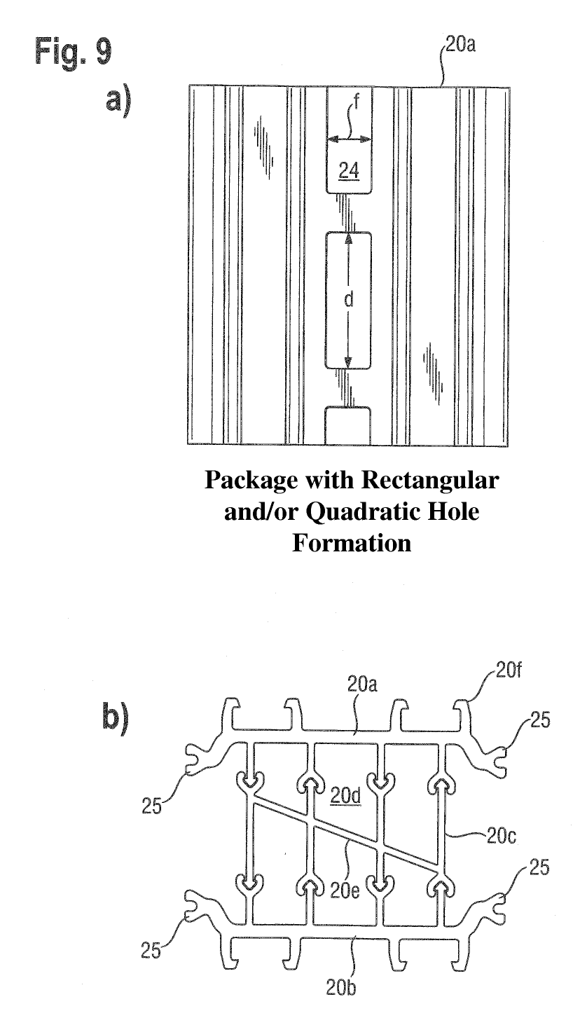

FIG. 9 shows a tenth embodiment of an insulating strip, in a) in plan view perpendicular to the longitudinal direction and in b) in the cross-section perpendicular to the longitudinal direction;

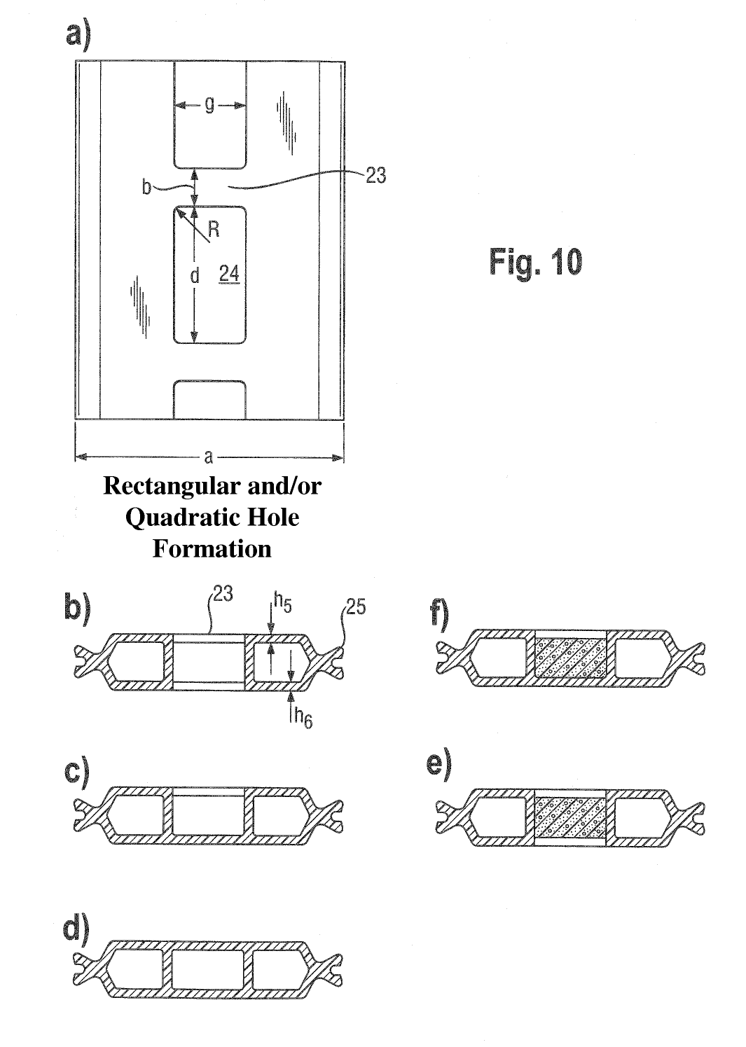

FIG. 10 shows an eleventh embodiment of an insulating strip, in a) in plan view perpendicular to the longitudinal direction, in b) in the cross-section perpendicular to the longitudinal direction, in c) in a modification of the cross-sectional shape perpendicular to the longitudinal direction, in d) a cross-section without openings, in e) a modification of the embodiment of b) with filling material, and in f) a modification of the modification of c) with filling material;

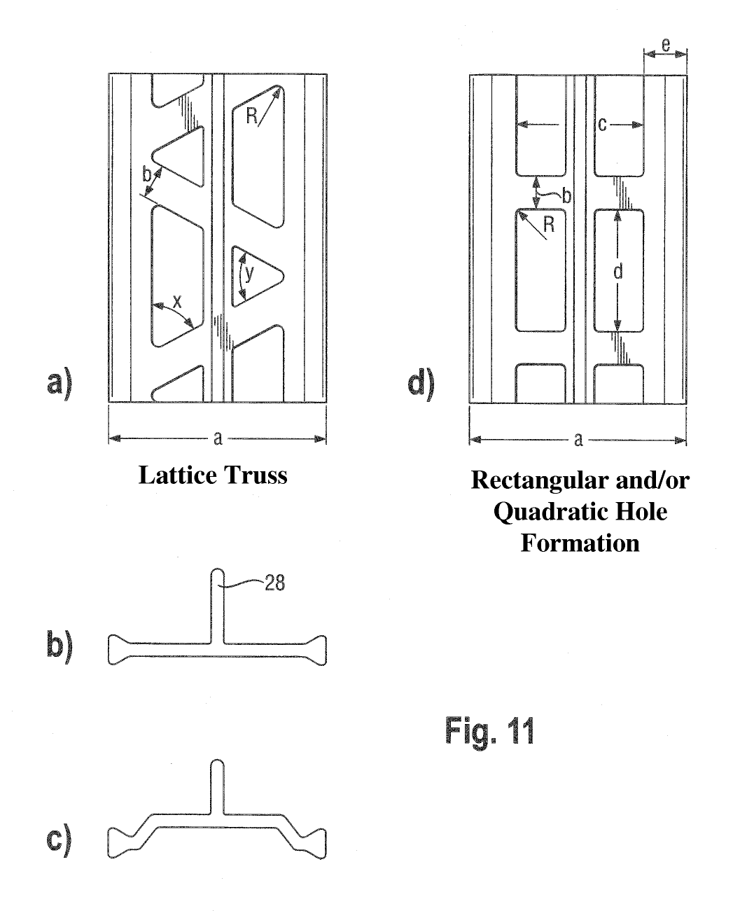

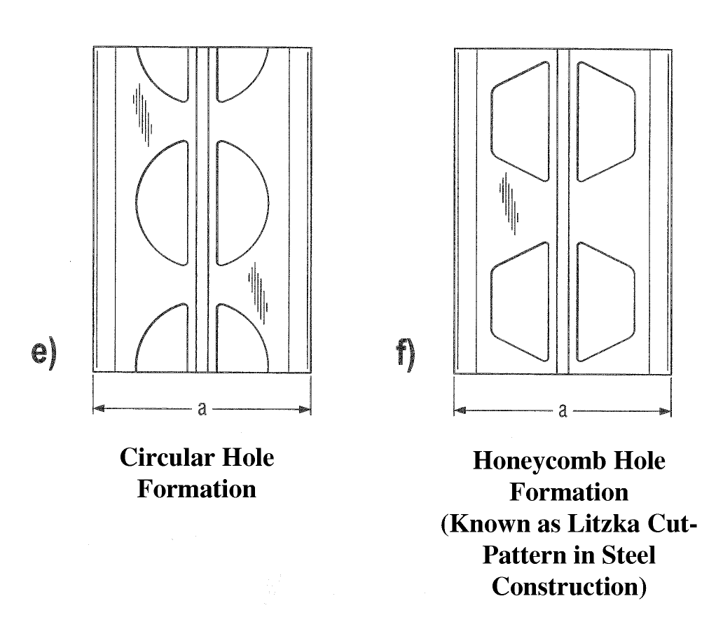

FIG. 11 shows modifications of the sixth to ninth embodiments in corresponding views; and

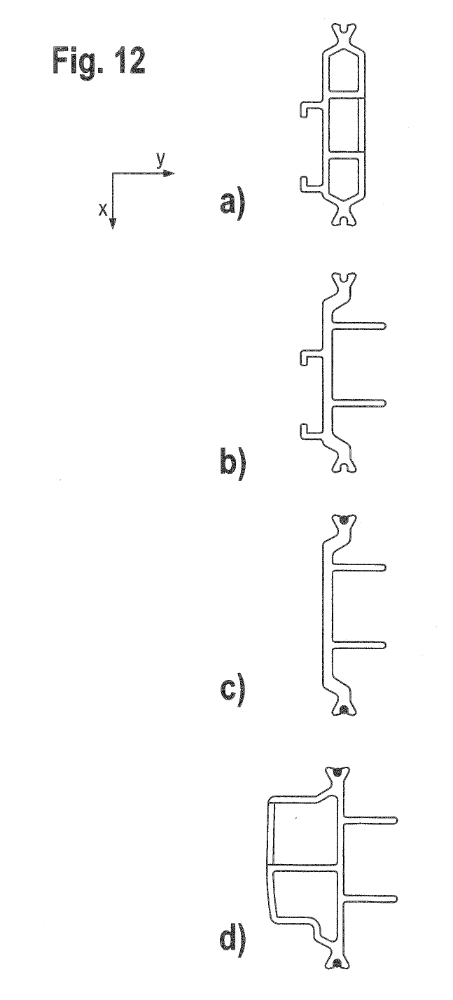

FIG. 12 shows in a) a modification of the embodiments from FIGS. 10 a) and c), in b) and c) modifications of the embodiments of FIGS. 8 and 11, and in d) a modification of the embodiment of FIG. 10.

In the insulating strips shown in FIGS. 1, 2, the rungs 23 of the insulating strip body 20, which is formed in a ladder-like manner, extend transverse to the longitudinal direction Z between the continuous longitudinal edges 21, 22. However, these could also extend slightly inclined (up to about 20°) to the transverse direction. The rungs could also have a curved shape. All rungs preferably, but not necessarily, have the same shape.

The longitudinal sides or edges 21, 22 are adapted for the (in the longitudinal direction Z) shear-resistant connection with profile parts 31, 32 (see FIG. 3) of the composite profile. In the illustrated embodiment, the longitudinal sides or edges 21, 22 are formed as roll-in heads 25 or roll-in projections for a rolling-in in grooves of the profile parts 31, 32, which are each formed by a roll-in hammer 33 and an opposing wall segment 34. Other types of connections, such as adhesion, etc. are also possible.

In plan view, the rungs 23 have a width b in the longitudinal direction z that is chosen in accordance with the required transverse tensile strength, the required transverse stiffness and the material utilized and falls within the range of 0.5 mm to 10 mm, preferably 1 mm to 5 mm, more preferably 1 mm to 3 mm. In a cross section perpendicular to the longitudinal direction, the rungs have a height (thickness) h (in direction y) that is chosen in accordance with the required transverse tensile strength, the required transverse stiffness and the material utilized and falls within the range of 0.5 mm to 10 mm, preferably 0.5 mm to 5mm, more preferably 0.7 mm to 2 mm. The rungs 23 are disposed in the longitudinal direction with constant spacings d between them, which spacings fall within the range of 1 mm to 100 mm, preferably 1 mm to 50 mm, more preferably 1 mm to 5 mm and more preferably 1 to 3 mm. Naturally, other widths, thicknesses, lengths and spacings are possible in accordance with the requirements.

First test results were obtained from ladder-like insulating strips with rungs that had, in the plan view in the longitudinal direction of the insulating strip, a width b of 1 mm in a first embodiment and a width of 3 mm in a second embodiment, and each had constant spacings d of about 3 mm in the longitudinal direction of the insulating strip. In the plan view, the rungs had a length c of about 14 mm long in the direction transverse to the longitudinal direction of the insulating strip with an overall dimension a of the insulating strip of about 23 mm in this direction. The insulating strips exhibited values for the transverse tensile strength (tension in the direction of the connection of the profile parts connected by the insulating strip, i.e. in direction x in FIGS. 1, 2), which values for both rung widths were higher than for comparable profiles according to DE 199 56 415 C1, and for the shear strength (relative displacement of the profile parts connected by the insulating strip in the longitudinal direction z of the profile parts, i.e. in the longitudinal direction z in FIGS. 1, 2), which could be adjusted in a simple manner by setting the rung widths to values below or above the values for comparable profiles according to DE 199 56 415 C1, so that the amount of the longitudinal displaceability is easily tailorable with a very high transverse tensile strength. These strips were designed to allow for a longitudinal displaceability, so that the so-called bi-metal problem is lessened.

FIG. 4 shows a third embodiment of an insulating strip having meander-shaped rungs of the ladder-like structure in a view corresponding to FIG. 1 a).

In the fourth embodiment of an insulating strip shown in FIG. 5, an in situ extruded cover (cover profile) 40 is provided for covering the intermediate spaces between the rungs. in a view corresponding to FIG. 1 c). The cover profile is integrally formed with the strip. As viewed in a cross section perpendicular to the longitudinal direction z, the cover profile is in situ extruded as a cover on one side of the rungs (as viewed in the x-direction) and its free end (edge) is clipped onto the other side of the rungs (as viewed in the x-direction). The clip-connection is constructed so that the clipping-in takes place in the height direction (y-direction).

In an alternative embodiment, which is shown in FIG. 6, the clip-connection is designed in another manner, so that it is clipped-in inclined to the height direction (y-direction) and a traction force in the transverse direction (x-direction) retains the clip in the engagement.

In the fifth embodiment shown in FIG. 7, the insulating strip body 20 is provided with clip heads (male clip parts) 28 on the rungs 23. These are disposed so that, in the height direction y, one clip head 28 is disposed on one side and two clip heads 28 are disposed on the other side. As a result, a single clip head 28 is disposed on the rung in the center in the transverse direction x, whereas the two other clip heads are disposed on the other side with identical distances from the center.

The clip heads each project by a height h₃ relative to the rest of the surface of the rungs 23 of the insulating strip body 20. The sum of the thickness h₁ in the height direction y and twice the projecting length h₃ is preferably identical to the thickness of the roll-in heads 25 in the height direction y.

In the fifth embodiment, a cover (cover profile) 40 is constructed so that it has three clip retainers (female clip parts) 48, of which the two outer ones have the same spacing as the two clip heads 28 located on one side of the insulating strip body 20 and the third clip retainer is disposed in the middle between these. As is implied by FIG. 7, such covers could be clipped onto both sides of the insulating strip body 20 without differently-formed covers being necessary. The insulating strip body 20 has a substantially constant thickness h₁ over a width a₁ in the transverse direction x. The width a₂ of the cover 40 in the transverse direction x is less than or the same as this width a₁ of the insulating strip body 20.

The cover has abutting lips 42 formed on its edges in the transverse direction x, which abutting lips 42 extend in the longitudinal direction Z. The clip retainers (female clip parts) 48 have a distance h₄ from the bottom of the clip retainer in the height direction y to the outermost point of the clip retainer, which distance h₄ is less than the height h₃ of the clip head 28. The lips 42 end in the height direction y at the height level of the clip retainers 48 or somewhat higher (see also FIG. 7 c)).

Plastic having a Young's modulus value of greater than 2000 N/mm² is advantageously utilized as the material for the insulating strip. Suitable plastics are polyamide, polyester or polypropylene, for example PA66.

The thickness h₁ of the insulating strip bodies of all embodiments falls within the range of 1 mm to 50 mm, preferably 1 mm to 10 mm, more preferably 1 mm to 2 mm, more preferably 1.4 to 1.8 mm. The thickness h₂ of the cover is preferably less than or equal to the thickness of the insulating strip body associated therewith.

The embodiment shown in FIGS. 5 and 6 is well-suited for smaller values of a in the range of 8 to 20 mm, for example, 14 mm. The thickness h₁ is then preferably, for example, 1.4 mm. The embodiment of FIG. 7 is well-suited for values of a in the range of 20 to 40 mm, e.g., 32 mm. In this case, the preferred thickness h₁ falls in the range of 1.5 to 1.8 mm. PA66 is preferred as the material for the stated widths and material thicknesses.

Because the insulating strip bodies are comprised of plastic, no metal inserts are present, i.e. they are formed without metal inserts.

In FIG. 8 a) an embodiment defined with regard to shear strength is illustrated in a plan view perpendicular to the longitudinal direction. The insulating strip has a width a in the x-direction in the range of 10 mm≦a≦100 mm. The insulating strip has openings 24 passing through the material of the strip in the height direction (thickness direction) y. The shape of the openings is substantially triangular in the plan view, with corners having an inner curvature of radius R. The height of the triangle in the transverse direction x is c. The triangles are disposed in an alternating manner. This means that, in the plan view in FIG. 8 a), one longitudinal side of each triangle is respectively disposed alternately parallel adjacent to the left side, then to the right side, then again to the left side, etc. From this, it also follows that the vertices are disposed in an alternating manner. Rungs 23 are located between the triangles and have a width b perpendicular to the sides of the triangles that border them. The triangles are spaced by a length e from the respective outer edges in the transverse direction. From that, it results that a=c+2e. The insulating strip has a height (thickness) h in the height direction over its entire width, except for the roll-in heads 25. The values are thus chosen as follows. For insulating strips having a<22 mm, c falls in the range of 7 to 10, preferably 8 mm. The radius R is <2 mm, preferably <1 mm, more preferably 0.5 mm. This radius serves to prevent a stress concentration and also to prevent the formation of a type of bending joint. The width of the rungs is 1 to 3 mm, preferably 2 mm.

For strips having a≧22 mm, c falls in the range of 8 to 18 mm, preferably 12 mm. The height h in the height direction y is 1.2 to 2.4 mm, preferably 1.8 mm. The strip is made from PA66GF25.

FIG. 8 c) shows a modification of the sixth embodiment in cross-section, in which the path of the strip between the two roll-in heads is not straight, as in FIG. 8 b).

FIG. 8 d) shows a seventh embodiment. The seventh embodiment differs from the sixth embodiment in that the openings are not substantially triangular, but rather are substantially rectangular. The cross-section perpendicular to the longitudinal direction can be as shown in FIGS. 8 b) or c). The dimension specifications for a, b, c, e or R for the sixth embodiment also apply to the seventh embodiment. The length d, i.e. the dimension of the openings in the longitudinal direction z, falls in the range of 3 to 8 mm, preferably 5 mm. This dimension d also applies to the preferred maximum dimension of the triangular openings in the sixth embodiment, even though the dimension d is not shown in FIG. 8 a).

FIG. 8 e) shows an eighth embodiment. The eighth embodiment differs from the sixth and seventh embodiment in that the openings are circular with a diameter having the dimension c. FIG. 8 f) shows a ninth embodiment that differs from the sixth and seventh embodiment in that the openings are six-sided. The remaining specifications for the sixth and seventh embodiments also apply, as far as they are applicable, to the eighth and ninth embodiments.

FIG. 9 shows, in a) in the plan view perpendicular to the longitudinal direction and in b) in the cross-section to the longitudinal direction, an insulating strip having a so-called package-design. This package-design is designed to be installed in a composite profile as is shown in an exemplary manner in the cross-section in FIG. 7 c). For this purpose, the four roll-in heads 25 are rolled into the corresponding four retainers, as is readily apparent from a comparison with FIG. 7. The upper insulating strip part 20a in FIG. 9 b) is thus rolled-in above in FIG. 7 c) and the lower insulating strip part 20b in FIG. 9 b) is thus rolled-in below in FIG. 7 c). Both insulating strip parts are connected by a clipped-on connecting piece 20c so that, on the one hand, a shield against convention and irradiation is achieved between the inner and outer sides of the composite profile and, on the other hand, a plurality of hollow chambers 20d is formed. The hollow chambers 20d are sub-divided in the height direction y by a diagonal strut 20e of the connecting piece 20c. As is easily recognizable in FIG. 9 a), openings 24 can be formed with a width in the transverse direction x and a longitudinal dimension d in the longitudinal direction z and can be formed in one or more insulating strip parts 20a, 20b and/or in the connecting piece 20c. Each of the insulating strip parts 20a and 20b shown in FIG. 9 d) also has outwardly-pointing projections 20f that can form the retainers for rubber seals and/or mounting parts. These are not an essential component of the depicted embodiment. The number of the openings and the width and length of the openings is not limited to the arrangement shown in FIG. 9 a).

The embodiment with modifications shown in FIG. 10 shows a so-called hollow chamber profile. In such a hollow chamber profile, hollow chambers are located between the roll-in projections 25 in the transverse direction x. In FIG. 10 d), the cross-section of a conventional hollow chamber profile is shown. As can be readily derived from the comparison with the cross-section of the eleventh embodiment in FIG. 10 b), the difference essentially consists in that the wall in the central hollow chamber between the rungs 23 is removed, i.e. openings 24 are formed. The openings have a width g in the transverse direction x and a length dimension d in the longitudinal direction z. In particular for hollow chamber profiles having a width a of ≧25 mm, the specifications for c) of the sixth to ninth embodiments can also be utilized for g). In the modification in FIG. 10 c), an opening 24 is formed only on one side of the hollow chambers. According to the modifications, which are shown in FIGS. 10 e) and f), the portion of the hollow chamber profile, in which one or more openings 24 are formed, is filled with a foam as a filling material. This foam is preferably a pur-foam that has a lower heat conductivity coefficient than the material formed for forming the insulating strip body.

FIGS. 11 a) to f) show modifications of the sixth to ninth embodiments in views having the same numbering a) to f), in each of which a projection 28 is formed that projects from the insulating strip body substantially in the height direction y. This projection 28 principally serves to obstruct convection and radiation. The height of the projection 8 in the height direction y is chosen accordingly. In FIG. 7 c), the installation of an insulating strip having such a projection 28 is indicated below in a dashed manner. If the insulating strip shown above in FIG. 7 c) has one or more corresponding projections 28, which overlap with the lower projection 28 as viewed in the transverse direction x, then a particularly effective hindering of the convection and radiation is achieved. FIGS. 12 b), c) and d) show modifications of insulating strips having two such projections 28.

All of the embodiments shown in FIGS. 8 to 12 are preferably provided with in situ extruded covers of the type shown in FIGS. 5, 6 or more preferably with clip projections and/or clip retainers of the type shown in FIG. 7. In the alternative, it is also possible to provide films for covering the openings or to perform a filling with a material of lesser heat conductivity than the material of the insulating strip body. The at least partially or entirely clipped-on covers or, if applicable, films are preferred.

Hard-PVC, PA, PET, PPT, PA/PPE, ASA and PA66 are possibilities for the material of the insulating strip body and PA66GF25 is preferred. Foams made of thermosetting plastics, such as PU having an appropriate density, are possibilities, preferably foams of lower density (0.01 to 0.3 kg/l).

Further applications of ladder-like profiles are directed to achieving a low shear strength (high longitudinal movability). In another application, openings are provided only to reduce the heat conductivity when a known, highly-conductive metal insert is used.

In the preferred embodiments having partially in situ extruded covers that are clipped onto the other side, wherein embodiments with completely clipped-on covers are particularly preferred, and also in the embodiments having adhered-on or laminated-on films, each for covering the openings, it is been determined in a surprising way for the entire or partially clipped-on covers that these only insubstantially influence the so-called U-values, i.e. the heat isolating characteristics of the insulating strip, as compared to not-covered versions. Thus, experiments with a solid strip having a cross-section of the type shown in FIG. 8 b), i.e. a strip without openings, which strip has a width of 25 mm, a height h of 1.8 mm and PA26GF25 as the material, resulted in a U-value (W/m²K) of 2.4.

An insulating strip of the type shown in FIG. 8 d) having c=8 mm, d=5 mm and b=2 mm resulted in a U-value of 2.15 W/m²K without covering. A corresponding strip having clipped-on covers according to FIG. 7 had a U-value of 2.25 W/m²K. The measurements were performed in a so-called “hot-box”, wherein a system with 25 mm wide, flat insulating strips was utilized as the initial system, which insulating strips were not exchanged during the course of the experiment. Therefore, the improvement of the U-values should be even better in reality.

Even though the cause of this effect is not completely clear, it is probably due to the design of the clip connections and thus the heat transmission path that is severely obstructed by the cover.

For the embodiments with the hollow chambers shown in FIGS. 9, 10, which are already utilized for systems having excellent insulating properties, these properties can be further improved. The usage of convention and/or radiation shielding projections 28 likewise increases this effect.

It is explicitly emphasized that all features disclosed in the description and/or the claims should be regarded as separate and independent of each other for the purpose of the original disclosure as well as for the purpose of restricting the claimed invention, independent of the combination of features in the embodiments and/or the claims. It is explicitly stated that all specifications of ranges or of groups of units disclose all possible intermediate values or sub-group of units for the purpose of original disclosure as well as for the purpose of restriction of the claimed invention, in particular also as a limit of a range indication.

1-6. (canceled)

7. An insulating strip for a composite profile for window-, door- and facade elements, comprising:
an insulating strip body extending in a longitudinal direction and having at least two longitudinal edges separated from each other in a transverse direction, the longitudinal edges being configured for a shear-resistant connection with profile parts of the composite profile, wherein a plurality of openings pass through at least one wall of the insulating strip body in a height direction, wherein ladder-rung-shaped strips separate the openings from each other in the longitudinal direction, and wherein the insulating strip body is configured for a clipped connection with a covering profile.

8. An insulating strip according to claim 7, further comprising at least one clip head projecting from at least one side in the height direction.

9. An insulating strip according to claim 8, further comprising at least one clip retainer having a recess extending in the height direction.

10. An insulating strip according to claim 7, further comprising at least one clip retainer having a recess extending in the height direction.

11. An insulating strip according to claim 10, further comprising a covering profile in situ extruded on the insulating strip body on one side of the openings as viewed in the transverse direction, wherein the covering profile and the insulating strip body are configured such that the covering profile clips onto the insulating strip body on the other side of the openings as viewed in the transverse direction.

12. An insulating strip according to claim 9, further comprising a covering profile in situ extruded on the insulating strip body on one side of the openings as viewed in the transverse direction, wherein the covering profile and the insulating strip body are configured such that the covering profile clips onto the insulating strip body on the other side of the openings as viewed in the transverse direction.

13. An insulating strip according to claim 8, further comprising a covering profile in situ extruded on the insulating strip body on one side of the openings as viewed in the transverse direction, wherein the covering profile and the insulating strip body are configured such that the covering profile clips onto the insulating strip body on the other side of the openings as viewed in the transverse direction.

14. An insulating strip according to claim 7, further comprising a covering profile in situ extruded on the insulating strip body on one side of the openings as viewed in the transverse direction, wherein the covering profile and the insulating strip body are configured such that the covering profile clips onto the insulating strip body on the other side of the openings as viewed in the transverse direction.

15. A covering profile for an insulating strip body having a width (a₁) in a transverse direction, the covering profile comprising:
a cover body having a width (a₂) in the transverse direction that is less than the width (a₁) of the insulating strip,
at least one retaining element disposed on the cover body and being selected from the group consisting of at least one clip head complementary to at least one clip retainer disposed on the insulating strip body and at least one clip retainer complementary to at least one clip head disposed on the insulating strip body, and
at least one abutment lip configured to abut the insulating strip body and extending in a longitudinal direction.

16. A composite profile for window-, door- and facade elements, comprising:
at least two profile parts and
at least one insulating strip according to claim 8, wherein the profile parts are connected with the insulating strip(s) in a shear-resistant manner.

17. A composite profile according to claim 16, further comprising a covering profile comprising:
a cover body having a width (a₂) in the transverse direction that is less than a width (a₁) of the insulating strip,
at least one clip retainer complementary to and engaging the at least one clip head disposed on the insulating strip body, and
at least one abutment lip contacting the insulating strip body and extending in a longitudinal direction.

18. A composite profile for window-, door- and facade elements, comprising:
at least two profile parts and
at least one insulating strip according to claim 10, wherein the profile parts are connected with the insulating strip(s) in a shear-resistant manner.

19. A composite profile according to claim 18, further comprising a covering profile comprising:
a cover body having a width (a₂) in the transverse direction that is less than a width (a₁) of the insulating strip,
at least one clip head complementary to and engaging the at least one clip retainer disposed on the insulating strip body, and
at least one abutment lip contacting the insulating strip body and extending in a longitudinal direction.

20. A composite profile for window-, door- and facade elements, comprising:
at least two profile parts and
at least one insulating strip according to claim 13, wherein the profile parts are connected with the insulating strip(s) in a shear-resistant manner.

21. A composite profile for window-, door- and facade elements, comprising:
at least two profile parts and
at least one insulating strip according to claim 14, wherein the profile parts are connected with the insulating strip(s) in a shear-resistant manner.

22. A composite profile for window-, door- and facade elements, comprising:
at least two profile parts and
at least one insulating strip according to claim 7, wherein the profile parts are connected with the insulating strip(s) in a shear-resistant manner.
